(19) United States
(12) Patent Application Publication
(10) Pub. No.: US 2024/0344629 A1
(43) Pub. Date: Oct. 17, 2024

(54) TIMED GAS CUT-OFF DEVICE AND GAS EQUIPMENT

(71) Applicant: NINGBO WANAN CO., LTD., Ningbo (CN)

(72) Inventors: Feng ZHANG, Ningbo (CN); Yunnan WEI, Ningbo (CN); Jinghui FAN, Ningbo (CN); Jianshen PAN, Ningbo (CN)

(21) Appl. No.: 18/223,550

(22) Filed: Jul. 19, 2023

(30) Foreign Application Priority Data
Apr. 17, 2023 (CN) 202320845758.X

(51) Int. Cl. F16K 31/48; F16K 21/04

(52) U.S. Cl. CPC F16K 31/485; F16K 21/04; F16K 31/60

(57) ABSTRACT

A timed gas cut-off device, which comprises a device body, comprising an inlet gas channel, an outlet gas channel and a valve rod channel; the inlet and outlet gas channels are respectively in communication with the valve rod channel, an accommodation chamber with a through hole communicating the accommodation chamber with the valve rod channel; a valve rod device, comprising a rod body slidably cooperating in the valve rod channel, a shim connected to the rod body and moves in synchronization with the rod body to open or close the valve rod channel; a free end of the rod body extends through the through hole and disposed inside the accommodation chamber; an elastic soft sealing piece, sealingly connected to the through hole, sleeved on the free end of the rod body; a timer with a drive piece connected inside the accommodation chamber for timed gas use and improves the safety.

This application is based upon and claims priority to Chinese Patent Application No. 202320845758.X, filed on Apr. 17, 2023, the entire contents of which are incorporated herein by reference.

### TECHNICAL FIELD

The present invention relates to the technical field of gas control equipment, and in particular to a timed gas cut-off device and a gas equipment.

### BACKGROUND

Gas valves are safety devices for a gas pipe engineering and used to cut off, convey or regulate gas in the pipes. Due to good control characteristics and closing sealing performance, the gas valves can be used in the pipes of various gas media such as city gas, liquefied petroleum gas, natural gas and oxygen and the like.

However, when using a gas equipment, people usually need to watch the gas equipment nearby to avoid burning-out or fire accidents occurring to the gas equipment after a long time of use. Further, a long time of use of the gas equipment may also cause gas wastes, unfavorable for environmental protection and energy savings.

### SUMMARY

In order to address the above technical shortcomings, the present invention provides a timed gas cut-off device to solve the technical problem that a person is required to watch a gas equipment during use in the prior arts.

In order to achieve the above technical purpose, according to a first aspect of the technical solutions of the present invention, there is provided a timed gas cut-off device, comprising:
a device body, comprising an inlet gas channel, an outlet gas channel and a valve rod channel, where the inlet gas channel and the outlet gas channel are respectively in communication with the valve rod channel, an accommodation chamber is further disposed in the device body, and a through hole communicating the accommodation chamber with the valve rod channel is disposed;
a valve rod device, comprising a rod body slidably cooperating in the valve rod channel, and a shim connected to the rod body, where the shim moves in synchronization with the rod body to open or close the valve rod channel, and a free end of the rod body extends through the through hole and is disposed inside the accommodation chamber;
an elastic soft sealing piece, sealingly connected to the through hole and is sleeved on the free end of the rod body;
a timer, connected inside the accommodation chamber, where the timer comprises a drive piece; in a timed state, the drive piece drives the movement of the free end of the rod body 142 to enable the shim to open the valve rod channel; and when the timing is ended, the drive piece stops driving the free end of the rod body and the shim closes the valve rod channel.

Compared with the prior arts, the present invention has the following beneficial effects.

The timed gas cut-off device of the present invention comprises: a device body, a timer and a valve rod device. The inlet gas channel, the outlet gas channel and the valve rod channel in mutual communication are disposed inside the device body and the inlet gas channel and the outlet gas channel can be communicated or cut off by cooperation of the timer and the valve rod device. In the present disclosure, a gas supply time may be preset by the timer and after expiration of the preset time, the gas supply is cut off, so as to satisfy the requirements of the users for timed gas use, reducing the risk of excessive gas combustion, improving the safety of the gas use, and bringing good practical value.

According to some embodiments of the present invention, the valve rod device further comprises an elastic component, where the elastic component enables the shim to always have a tendency to close the valve rod channel.

According to some embodiments of the present invention, the sealing piece further has an annular turning edge, and an end of the through hole close to the valve rod channel is provided with an inwardly-concaved annular step, and thus, the annular turning edge can be sealingly connected to the annular step. Moreover, a top plate pressed on the annular turning edge is connected on the annular step.

According to some embodiments of the present invention, the sealing piece is shaped like cone and an inner wall of the through hole is disposed as a cone matching the sealing piece.

According to some embodiments of the present invention, a hand wheel is mounted at an opening of the accommodation chamber and connected with the timer. The hand wheel is used to rotate the timer.

According to some embodiments of the present invention, in addition to the elastic component which is a spring, the valve rod device further comprises: a pressing plate, where the pressing plate and the shim are coaxially disposed, and the spring is mounted between a cover piece and the pressing plate.

According to some embodiments of the present invention, the drive piece is a toggle sheet.

According to some embodiments of the present invention, a sieve is disposed in the inlet gas channel and the outlet gas channel.

According to some embodiments of the present invention, time graduations are disposed on an outer edge of the hand wheel.

According to some embodiments of the present invention, a plurality of screw holes for mounting are disposed on the device body.

According to a second aspect of the present invention, there is provided a gas equipment, including the timed gas cut-off device described in any one item of the first aspect.

The additional aspects and advantages of the present invention will be partially given in the following descriptions and partially become apparent from the following descriptions or understood from the practice of the present invention.

### BRIEF DESCRIPTION OF THE DRAWINGS

FIG. 1 is a structural schematic diagram illustrating a timed gas cut-off device according to an embodiment of the present invention.

FIG. 2 is a structural schematic diagram illustrating a timed gas cut-off device according to another embodiment of the present invention.

FIG. 3 is a structural schematic diagram illustrating a valve rod device of a timed gas cut-off device according to another embodiment of the present invention.

FIG. 4 is a structural schematic diagram illustrating a valve rod device of a timed gas cut-off device according to another embodiment of the present invention.

FIG. 5 is a schematic diagram illustrating a sectional structure of a valve rod device of a timed gas cut-off device according to another embodiment of the present invention.

Numerals of the drawings are described below: 110. device body, 111. inlet gas channel, 112. outlet gas channel, 120. timer, 130. hand wheel, 140. valve rod device, 141. sealing piece, 142. rod body, 143. pressing plate, 144. shim, 150. cover piece, 160. elastic component, and 170. toggle sheet.

### DETAILED DESCRIPTIONS OF EMBODIMENTS

In order to make the objects, technical solutions and advantages of the present invention clearer and more intelligible, the present invention will be further described in details in combination with drawings and specific embodiments. It should be understood that the specific embodiments described herein are used only to interpret the present invention rather than limit the present invention.

The embodiments of the present invention will be described below in details with the examples thereof shown in the accompanying drawings, and the same or similar reference numerals represent same or similar elements or elements having same or similar function throughout the specification. The embodiments described by referring to the drawings below are only illustrative and used only to interpret the present invention rather than understood as limiting of the present invention.

In the descriptions of the present invention, it is to be understood that the orientations or positional relationships indicated by the terms such as upper, lower, front, rear, left and right are based on the orientations or positional relationships shown in the drawings and used only to facilitate descriptions of the present invention and simplify the descriptions rather than indicate or imply the indicated device or element must have a specific orientation, or be constructed and operated in a specific orientation, and thus shall not be understood as limiting of the present invention.

In the descriptions of the present invention, several refers to one or plural, and the plural refers to two or more; the terms “greater than” “less than” and “exceed” and the like are understood as excluding the present number, and the terms “above”, “below” and “within” are understood as including the present number. The terms “first” and “second” and the like are used to distinguish technical features and shall not be understood as indicating or implying relative importance or implicitly indicating the number of the indicated technical features or implicitly indicating a sequence relationship of the indicated technical features.

In the descriptions of the present invention, unless otherwise stated clearly, the terms “dispose”, “mount” and “connect” and the like shall be understood in a broad sense, and those skilled the art may determine the specific meanings of the above terms in the present invention based on the specific contents of the technical solution.

The present invention provides a timed gas cut-off device, which can supply gas within a period set by a timer and cut off the gas supply upon expiration of the set period, so as to satisfy the requirements of users for timed gas use.

In the related arts, ZL200720085642.1 provides a wheel disk type timed gas valve for a gas range, where a valve rod is controlled through a notch of a timed wheel disk to start and cut off gas supply.

The embodiments of the present invention will be further set forth in combination with the drawings.

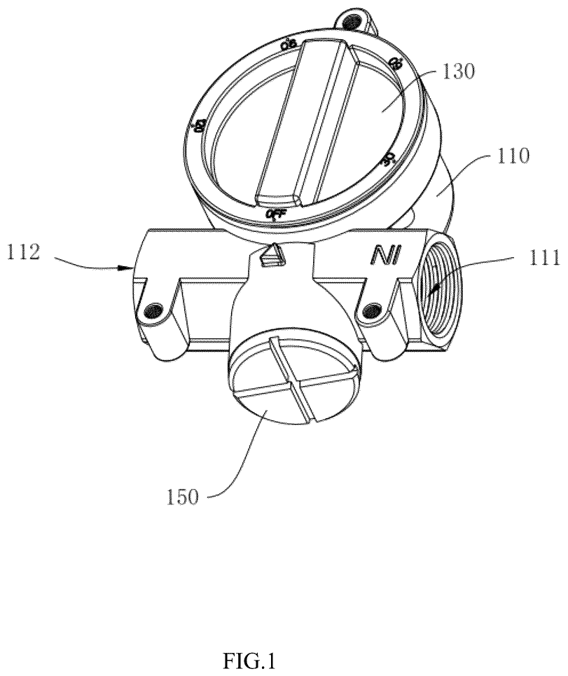

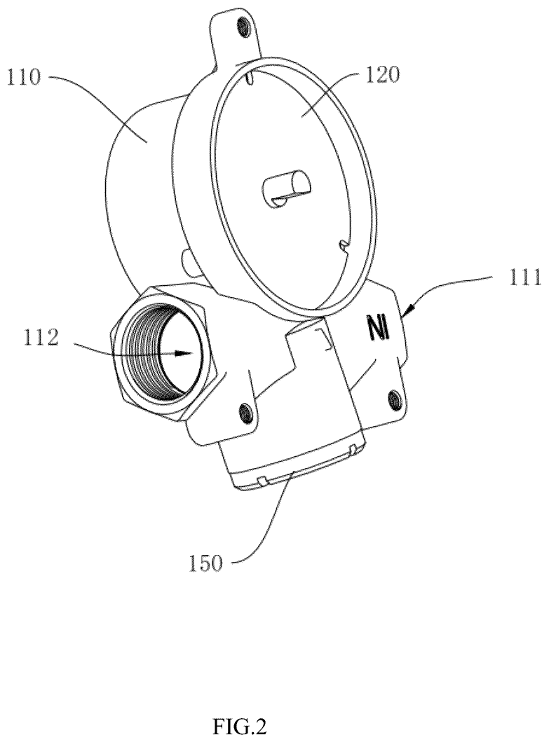

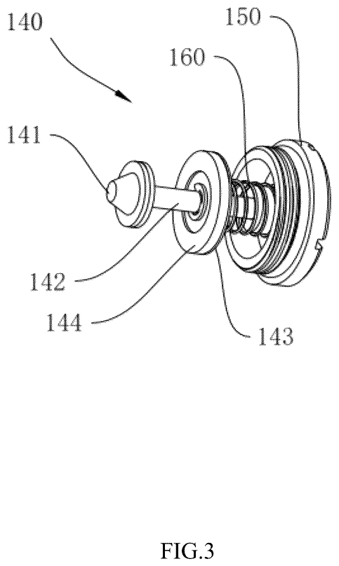

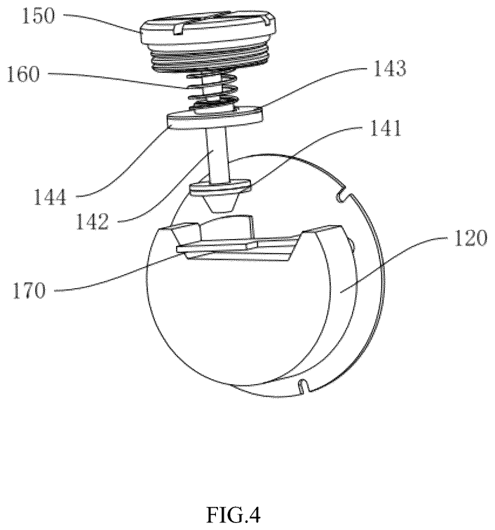

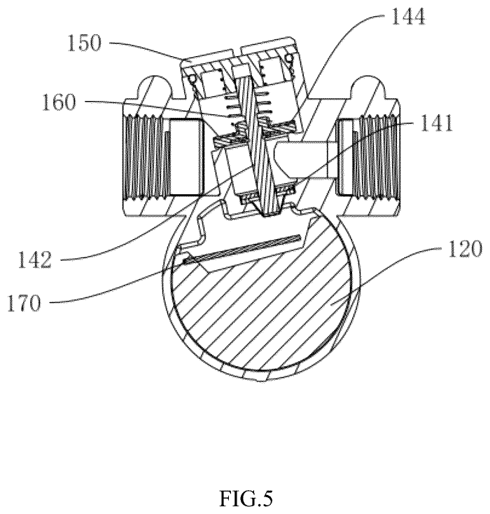

FIG. 1 is a structural schematic diagram illustrating a timed gas cut-off device according to an embodiment of the present invention. FIG. 2 is a structural schematic diagram illustrating a timed gas cut-off device according to another embodiment of the present invention. FIG. 3 is a structural schematic diagram illustrating a valve rod device of a timed gas cut-off device according to another embodiment of the present invention. FIG. 4 is a structural schematic diagram illustrating a valve rod device of a timed gas cut-off device according to another embodiment of the present invention. FIG. 5 is a schematic diagram illustrating a sectional structure of a valve rod device of a timed gas cut-off device according to another embodiment of the present invention.

In an embodiment, the timed gas cut-off device comprises: a device body 110, a valve rod device 140, an elastic soft sealing piece 141, and a timer 120. The device body 110 comprises an inlet gas channel 111, an outlet gas channel 112 and a valve rod channel, where the inlet gas channel 111 and the outlet gas channel 112 are respectively in communication with the valve rod channel. An accommodation chamber is further disposed in the device body 110 and a through hole communicating the accommodation chamber with the valve rod channel is disposed. The valve rod device 140 comprises a rod body 142 slidably cooperating in the valve rod channel, and a shim 144 connected to the rod body 142, where the shim 144 moves in synchronization with the rod body 142 to open or close the valve rod channel, and a free end of the rod body 142 extends through the through hole and is disposed inside the accommodation chamber. The elastic soft sealing piece 141 is sealingly connected to the through hole and is sleeved on the free end of the rod body 142. The timer 120 is connected inside the accommodation chamber. The timer 120 comprises a drive piece. In a timed state, the drive piece drives the movement of the free end of the rod body 142 to enable the shim 144 to open the valve rod channel; and when the timing is ended, the drive piece stops driving the free end of the rod body 142 and the shim 144 closes the valve rod channel.

The drive piece may be a toggle sheet 170.

In the present disclosure, a gas supply time may be preset by the timer 120 and after expiration of the preset time, the gas supply is cut off, so as to satisfy the requirements of the users for timed gas use, reducing the risk of excessive gas combustion, improving the safety of the gas use, and bringing good practical value. The timer 120 in the present disclosure may be a clockwork timer or electromagnetic drive timer, which is not limited herein.

Furthermore, the valve rod device 140 further comprises an elastic component 160 which enables the shim 144 to always have a tendency to close the valve rod channel. The elastic component 160 may be abutted against the bottom of the rod body and may also be abutted against the position of the shim 144 to realize the automatic spring-back function of the shim 144.

Furthermore, the sealing piece 141 has an annular turning edge and an end of the through hole close to the valve rod channel is provided with an inwardly-concaved annular step, and thus, the annular turning edge can be sealingly connected to the annular step. Moreover, a top plate pressed on the annular turning edge is connected on the annular step, which can effectively improve the connection reliability between the sealing piece and the valve rod channel.

Furthermore, the sealing piece 141 is shaped like cone and an inner wall of the through hole is disposed as a cone matching the sealing piece. The cone-shaped disposal of the sealing piece 141 can increase a sealing area and improve a sealing reliability.

In an embodiment, the timed gas cut-off device comprises: a device body 110, a valve rod device 140, an elastic soft sealing piece 141, and a timer 120. The device body 110 comprises an inlet gas channel 111, an outlet gas channel 112 and a valve rod channel, where the inlet gas channel 111 and the outlet gas channel 112 are respectively in communication with the valve rod channel. An accommodation chamber is further disposed in the device body 110 and a through hole communicating the accommodation chamber with the valve rod channel is disposed. The valve rod device 140 comprises a rod body 142 slidably cooperating in the valve rod channel, and a shim 144 connected to the rod body 142, where the shim 144 moves in synchronization with the rod body 142 to open or close the valve rod channel, and a free end of the rod body 142 extends through the through hole and is disposed inside the accommodation chamber. The elastic soft sealing piece 141 is sealingly connected to the through hole and is sleeved on the free end of the rod body 142. The timer 120 is connected inside the accommodation chamber. The timer 120 comprises a drive piece. In a timed state, the drive piece drives the movement of the free end of the rod body 142 to enable the shim 144 to open the valve rod channel; and when the timing is ended, the drive piece stops driving the free end of the rod body 142 and the shim 144 closes the valve rod channel. A hand wheel 130 is mounted at an opening of the accommodation chamber and connected with the timer 120. The hand wheel 130 is used to rotate the timer 120. The structure of the hand wheel 130 for rotating the timer 120 is simple and reliable.

Time graduations are disposed on an outer edge of the hand wheel 130, and a marking point may be disposed at a position of the device body 110 close to the hand wheel 130. The marking point and the time graduations on the outer edge of the hand wheel 130 may cooperate mutually to display a remaining gas supply time of the timed gas cut-off device.

It can be understood that, since the environment where the gas equipment is used is complex, for example, there are usually dusts and fumes in the environment, an annular step may be disposed at the opening of the accommodation chamber of the device body 110 and an edge shape of the hand wheel 130 is matched with the annular step, such that the hand wheel 130 can be closely mounted at the opening of the accommodation chamber. In this way, the sealing performance of the timed gas cut-off device can be improved, and the risk of foreign matters entering the device is reduced and hence, the reliability of the device is enhanced.

In an embodiment, the timed gas cut-off device comprises: a device body 110, a valve rod device 140, an elastic soft sealing piece 141, and a timer 120. The device body 110 comprises an inlet gas channel 111, an outlet gas channel 112 and a valve rod channel, where the inlet gas channel 111 and the outlet gas channel 112 are respectively in communication with the valve rod channel. An accommodation chamber is further disposed in the device body 110 and a through hole communicating the accommodation chamber with the valve rod channel is disposed. The valve rod device 140 comprises a rod body 142 slidably cooperating in the valve rod channel, and a shim 144 connected to the rod body 142, where the shim 144 moves in synchronization with the rod body 142 to open or close the valve rod channel, and a free end of the rod body 142 extends through the through hole and is disposed inside the accommodation chamber. The elastic soft sealing piece 141 is sealingly connected to the through hole and is sleeved on the free end of the rod body 142. The timer 120 is connected inside the accommodation chamber. The timer 120 comprises a drive piece. In a timed state, the drive piece drives the movement of the free end of the rod body 142 to enable the shim 144 to open the valve rod channel; and when the timing is ended, the drive piece stops driving the free end of the rod body 142 and the shim 144 closes the valve rod channel. A cover piece 150 is mounted at an opening of the valve rod channel. In addition to the elastic component 160 which is a spring, the valve rod device 140 further comprises: a pressing plate 143, where the pressing plate 143 and the shim 144 are coaxially disposed, and the spring is mounted between the cover piece 150 and the pressing plate 143.

The valve rod device 140 comprises: the pressing plate 143, the shim 144 and the rod body 142, where the pressing plate 143 and the shim 144 are coaxially disposed. A hole matching a diameter of the rod body 142 is disposed in the pressing plate 143 and the shim 144, and the rod body 142 penetrates through the hole. The spring is mounted between the cover piece 150 and the pressing plate 143. The disposal of the cover piece 150 at the opening of the valve rod channel facilitates the assembling of the valve rod device 140 and the elastic component 160 during production. The elastic component 160 may be a spring which is simple in structure and easy to mount. Certainly, the elastic component 160 may also be a spring sheet or the like, and the pressing plate 143 is used to hold the spring to provide support for the shim 144.

Furthermore, a sealing ring is disposed between the cover piece 150 and the device body 110 to avoid gas leakage occurring to the connection between the cover piece 150 and the device body 110, thus ensuring the operation safety and reliability of the device.

In an embodiment, the timed gas cut-off device comprises: a device body 110, a valve rod device 140, an elastic soft sealing piece 141, and a timer 120. The device body 110 comprises an inlet gas channel 111, an outlet gas channel 112 and a valve rod channel, where the inlet gas channel 111 and the outlet gas channel 112 are respectively in communication with the valve rod channel. An accommodation chamber is further disposed in the device body 110 and a through hole communicating the accommodation chamber with the valve rod channel is disposed. The valve rod device 140 comprises a rod body 142 slidably cooperating in the valve rod channel, and a shim 144 connected to the rod body 142, where the shim 144 moves in synchronization with the rod body 142 to open or close the valve rod channel, and a free end of the rod body 142 extends through the through hole and is disposed inside the accommodation chamber. The elastic soft sealing piece 141 is sealingly connected to the through hole and is sleeved on the free end of the rod body 142. The timer 120 is connected inside the accommodation chamber. The timer 120 comprises a drive piece. In a timed state, the drive piece drives the movement of the free end of the rod body 142 to enable the shim 144 to open the valve rod channel; and when the timing is ended, the drive piece stops driving the free end of the rod body 142 and the shim 144 closes the valve rod channel. A sieve is disposed in the inlet gas channel 111 and the outlet gas channel 112 to prevent large foreign matters entering the interior of the timed gas cut-off device, so as to improve the operation reliability of the device.

In an embodiment, the timed gas cut-off device comprises: a device body 110, a valve rod device 140, an elastic soft sealing piece 141, and a timer 120. The device body 110 comprises an inlet gas channel 111, an outlet gas channel 112 and a valve rod channel, where the inlet gas channel 111 and the outlet gas channel 112 are respectively in communication with the valve rod channel. An accommodation chamber is further disposed in the device body 110 and a through hole communicating the accommodation chamber with the valve rod channel is disposed. The valve rod device 140 comprises a rod body 142 slidably cooperating in the valve rod channel, and a shim 144 connected to the rod body 142, where the shim 144 moves in synchronization with the rod body 142 to open or close the valve rod channel, and a free end of the rod body 142 extends through the through hole and is disposed inside the accommodation chamber. The elastic soft sealing piece 141 is sealingly connected to the through hole and is sleeved on the free end of the rod body 142. The timer 120 is connected inside the accommodation chamber. The timer 120 comprises a drive piece. In a timed state, the drive piece drives the movement of the free end of the rod body 142 to enable the shim 144 to open the valve rod channel; and when the timing is ended, the drive piece stops driving the free end of the rod body 142 and the shim 144 closes the valve rod channel. A plurality of screw holes for mounting are disposed on the device body 110 to facilitate the mounting operation.

The present invention further provides a gas equipment comprising the above timed gas cut-off device.

The above detailed descriptions are made to the embodiments of the present invention in combination with the drawings, but the present invention is not limited to the above embodiments. Those skilled in the art may make various changes to the present invention within their scope of the knowledge without departing from the tenet of the present invention.

The above specific embodiments of the present invention do not constitute any limitation to the scope of protection of the present invention. Various other corresponding changes and variations made based on the technical idea of the present invention shall fall within the scope of protection of the claims of the present invention.

1. A timed gas cut-off device, wherein the device comprises:
a device body (110), comprising an inlet gas channel (111), an outlet gas channel (112) and a valve rod channel, and the inlet gas channel (111) and the outlet gas channel (112) are respectively in communication with the valve rod channel, an accommodation chamber is further disposed in the device body (110), and a through hole communicating the accommodation chamber with the valve rod channel is disposed;
a valve rod device (140), comprising a rod body (142) slidably cooperating in the valve rod channel, and a shim (144) connected to the rod body (142), and the shim (144) moves in synchronization with the rod body (142) to open or close the valve rod channel, and a free end of the rod body (142) extends through the through hole and is disposed inside the accommodation chamber;
an elastic soft sealing piece (141), sealingly connected to the through hole and is sleeved on the free end of the rod body (142);
a timer (120), connected inside the accommodation chamber, and the timer (120) comprises a drive piece; in a timed state, the drive piece drives the movement of the free end of the rod body (142) to enable the shim (144) to open the valve rod channel; and when the timing is ended, the drive piece stops driving the free end of the rod body (142) and the shim (144) closes the valve rod channel.

2. The timed gas cut-off device of claim 1, wherein the valve rod device (140) further comprises an elastic component (160), and the elastic component (160) enables the shim (144) to always have a tendency to close the valve rod channel.

3. The timed gas cut-off device of claim 1, wherein the sealing piece (141) further comprises an annular turning edge, and an end of the through hole close to the valve rod channel is provided with an inwardly-concaved annular step, with an annular turning edge sealingly connected to the annular step and a top plate pressed on the annular turning edge is connected on the annular step.

4. The timed gas cut-off device of claim 3, wherein the sealing piece (141) is shaped like cone and an inner wall of the through hole is disposed as a cone matching the sealing piece (141).

5. The timed gas cut-off device of claim 1, wherein a hand wheel (130) is mounted at an opening of the accommodation chamber and connected with the timer (120), and the hand wheel (130) is used to rotate the timer (120).

6. The timed gas cut-off device of claim 2, wherein the elastic component (160) is a spring, and the valve rod device (140) further comprises: a pressing plate (143), and the pressing plate (143) and the shim (144) are coaxially disposed, and the spring is mounted between a cover piece (150) and the pressing plate (143).

7. The timed gas cut-off device of claim 1, wherein the drive piece is a toggle sheet (170).

8. The timed gas cut-off device of claim 1, wherein a sieve is disposed in the inlet gas channel (111) and the outlet gas channel (112).

9. The timed gas cut-off device of claim 1, wherein a plurality of screw holes for mounting are disposed on the device body (110).

10. A gas equipment, wherein the equipment comprises the timed gas cut-off device of claim 1.
